(19) United States
(12) Patent Application Publication
(10) Pub. No.: US 2009/0327488 A1
(43) Pub. Date: Dec. 31, 2009

(54) Method and System for Implementing Consumer Choice in a Targeted Message Delivery System

(75) Inventors: Miten Sampat, San Francisco, CA (US); Jasminder Banga, San Francisco, CA (US); Nitin Shah, Cupertino, CA (US); Don Lloyd Cook, Little Rock, AR (US); Amul Patel, Pacifica, CA (US)

Correspondence Address: COURTNEY STANIFORD & GREGORY LLP, 10001 N. De Anza Blvd., Suite 300, Cupertino, CA, 95014, US

(73) Assignee: FEEVA TECHNOLOGY, INC., San Francisco, CA (US)

(21) Appl. No.: 12/493,098

(22) Filed: Jun. 26, 2009

Related U.S. Application Data
(60) Provisional application No. 61/076,118, filed on Jun. 26, 2008.

(51) Int. Cl. G06F 15/173; G06Q 10/00; G06Q 50/00; G06F 15/16

(52) U.S. Cl. 709/224; 705/10; 709/206

(57) ABSTRACT

Embodiments are directed to a method and system of providing a centralized consumer choice process covering multiple Internet-based content services. The method comprises transmitting a consumer choice notification message to a user, receiving an indication of consumer choice with regard to gathering, storing or sharing of consumer information and activity during user Internet activity, wherein the consumer choice may comprise one of an opt-out or opt-in selection, storing the indicated consumer choice in a customer relationship management module, and setting a protocol in a network routing device to tag network traffic bound for a remote Internet-based content service indicating the user's choice. In one embodiment, reception of the tag indicates to the Internet-based content services that the user has agreed to participate in the gathering, storing, or sharing of defined user information, and the absence of a tag indicates that the user has declined to participate in the gathering, storing, or sharing of defined user information. Alternatively, two different types of tags may be provided to indicate the user's choice with respect to opt-in or opt-out.

### CROSS-REFERENCE TO RELATED APPLICATIONS

The present application claims the benefit of the U.S. Provisional Application No. 61/076,118 entitled “Method and System for Implementing Consumer Choice in a Targeted Message Delivery System,” and filed on Jun. 26, 2008.

### FIELD

Embodiments of the present invention relate generally to computer network systems, and more specifically to targeted delivery of Internet content, and subscription services from Internet Service Providers.

### BACKGROUND

An Internet service provider (ISP), also called Internet access provider (IAP) provides access for users to the Internet and related services. ISPs have traditionally been operated by the phone companies, but now, ISPs can be started by just about anyone with sufficient money and expertise. ISP's provide Internet access for users via various technologies such as dial-up and digital subscriber line (DSL), cable systems, mobile networks, and the like. They may also provide a combination of other services including domain name registration and hosting, web hosting, co-location, and other similar services.

Many ISPs work in conjunction with advertisers and other targeted message providers to serve directed ads to users during the normal course of a user's web browsing session. Ad serving represents a very significant industry and represents the bulk of funding available to content providers, and social networking websites. Effective ad serving requires some degree of information about individual users. Various companies have been formed to gather user information, compile user profiles, create ad-serving technologies, and develop targeted ad campaigns to help advertisers and content providers more effectively target specific audiences. Such activities often involve some degree of potential privacy concerns as information is harvested from users, and online traffic patterns are tracked and stored. Such methods typically involve the use of cookies, which are data objects that are placed directly on the user's computer itself, often without the user's knowledge or consent. These techniques have increasingly implicated privacy and personal security concerns, as such methods and information can be potentially harmful to users if they are abused. Indeed, the Federal Government has increasingly become involved in proposing limits to certain online ad campaign behavior in light of growing privacy concerns. For example, activities such as tracking online browsing patterns and search terms entered by users—for purposes of behavioral targeting have been widely criticized. Other technologies, such as deep packet inspection (that allows for capture of entire client communications), flash cookies, and the like are also considered problematic in view of heightened privacy concerns.

One significant problem associated with present advertising, and similar targeted message systems is that they are almost always implemented as an opt-out system in which user activity is tracked and information is gathered and used by default; unless the user explicitly opts out. Although users can opt out of having their information gathered and used, such opt-out strategies are often not effective or are overly burdensome, due to user ignorance of such options and/or difficult or non-intuitive methods for opting out. Also, because it is not often in the best interest for advertising and content providers to have opt-out, users are frequently encouraged or effectively forced to opt back in to such systems. Typically, opt-out systems built around the concept of opt-out cookies are counter intuitive from a consumer perspective. Consumers use cookie deletion software, to disallow websites from persistently collecting profile information about themselves. However, in a cookie based opt-out regime, the same cookie deletion software removes the opt-out cookies; in effect opting the user back in to the tracking systems. Thus, the ecosystem requires a reliable opt-out mechanism to afford the consumer a meaningful choice.

### BRIEF DESCRIPTION OF THE DRAWINGS

Embodiments are illustrated by way of example and not limitation in the figures of the accompanying drawings, in which like references indicate similar elements and in which:

FIG. 1A illustrates a high level architectural view of a system that generates tagged Internet traffic, under an embodiment.

FIG. 1B illustrates a system architecture and process flow for implementing an opt-out scheme, under an embodiment.

FIG. 1C illustrates a system architecture and process flow for implementing an opt-out scheme, under an alternative embodiment.

FIG. 2 illustrates a client-server network including a network tagging component, according to an embodiment.

FIG. 3 is a flowchart that illustrates a method of generating a request ID, under an embodiment.

FIG. 4 is a flowchart that illustrates a method of tagging network traffic with relevant user and/or network client information, under an embodiment.

FIG. 5 illustrates an example HTTP header including a network traffic tag, according to an embodiment.

FIG. 6 illustrates the composition of the Request ID (RID) tag, under an embodiment.

FIG. 7 illustrates a network system including a tag processor component within a router for multiple different client devices, under an embodiment.

FIG. 8 is a flowchart illustrates a method of implementing a consumer choice scheme in a network environment, under an embodiment

### INCORPORATION BY REFERENCE

Each publication and/or patent mentioned in this specification is herein incorporated by reference in its entirety to the same extent as if each individual publication or patent was specifically and individually indicated to be incorporated by reference.

### DETAILED DESCRIPTION

Embodiments are directed to a network interface system that addresses certain key consumer choice and privacy considerations associated with Internet use. Such a system facilitates consumer notification and provides methods for the consumer to make a meaningful choice with regard to information gathering and use. Embodiments include a method of implementing a centralized consumer choice process covering multiple Internet-based content services. The method comprises transmitting a consumer choice notification message to a user, receiving an indication of consumer choice with regard to gathering, storing or sharing of consumer information and activity during user Internet activity, wherein the consumer choice may comprise one of an opt-out or opt-in selection, storing the indicated consumer choice in a customer relationship management module, and setting a protocol in a network routing device to tag network traffic bound for a remote Internet-based content service indicating the user's choice. In one embodiment, reception of the tag indicates to the Internet-based content services that the user has agreed to participate in the gathering, storing, or sharing of defined user information, and the absence of a tag indicates that the user has declined to participate in the gathering, storing, or sharing of defined user information. Alternatively, two different types of tags may be provided to indicate the user's choice with respect to opt-in or opt-out.

As the online advertising marketplace is forecast to grow exponentially over the next three years, the Internet advertising community is looking for more effective ways to optimize their ROI (return on investment). Traditional methods of targeting ad messages to Internet users are reaching their limits in terms of providing an effective targeting tool. The pervasive use of cookies, for example, has led to a situation in which it has been found that up to 30% of primary source cookies are deleted by users, and up to 70% of secondary source (e.g., third party advertiser) cookies are deleted by users. This clearly shows the growing ineffectiveness of present cookie technology for an important class of content providers. Broadband internet service providers (ISP) and other providers are faced with ever-increasing margin and revenue pressures as the market begins to stabilize its growth trajectory.

Embodiments described herein are directed to a unique solution that helps address the issues facing ISPs and content providers with respect to both effective targeting of appropriate users and providing robust mechanisms to ensure consumer privacy and meaningful consumer choice. In one embodiment, a real-time market segmentation platform (the segmentation system) transforms traditional broadband internet service providers into a profitable ad-serving channel, while creating unprecedented capabilities for the digital marketing ecosystem. The segmentation system allows for secure extraction of audience intelligence that traditionally lay dormant in ISPs' data warehouses. This audience intelligence is further refined per the requirements of the Internet environment and distributed using standards friendly protocols. Specifically, a network element product is deployed within ISP networks to insert tags into the traffic stream of HTTP request headers. The HTTP headers are originated by a web browser when it makes a request for web content, such as a webpage. In one embodiment, the tags are an alphanumeric representation of user profile data that are appended to the HTTP requests made by the user's web browser. Embodiments of such a tagging system are described in co-pending application Ser. No. 12/045,693, entitled “Methods and Apparatus for Tagging Network Traffic Using Extensible Fields in Message Headers,” and which is assigned to the assignee of the present application.

In general, there is an absence in the participation of the ISP's in bringing benefits to the online content and advertising systems. Embodiments of the segmentation system and a related consumer choice component allow ISP's to participate by bringing this information in a meaningful and safe manner. For example, for digital marketing applications, the system provides improved capabilities in the design, optimization, and delivery of marketing campaigns. The use of tags allows high levels of geographic accuracy with which digital marketers are able to craft messages with a high degree of confidence of reaching the most appropriate audiences.

In one embodiment, the system utilizes tags in order to generate tagged traffic directly at the ISP level. This is distinctly different from present cookie technology, which operates at the user computer level. Although the concept of cookies initially generated some concerns among consumers, the web-surfing public has gradually become accustomed to the concept of cookies and the general utility that they provide. There are two general types of cookies, persistent and session. Persistent cookies stay on the computer and record information every time a consumer visits some websites. They are stored on the hard drive of the computer until manually deleted from a browser folder, or until they expire, which can be months or years after they were placed on the computer. Session cookies may help with navigation on the website and typically only record information during one visit to a website and then are erased. In the case of session cookies, a user can simply close the web browser or turn off the computer's power, and the session cookies will be deleted automatically. Most cookies can be managed by using cookie deletion software or adjusting the web browser settings. Much more troubling to consumers and to the privacy advocacy organization, however, is the use of flash cookies, which are very difficult to delete for the average consumers and which are not affected by cookie deletion software.

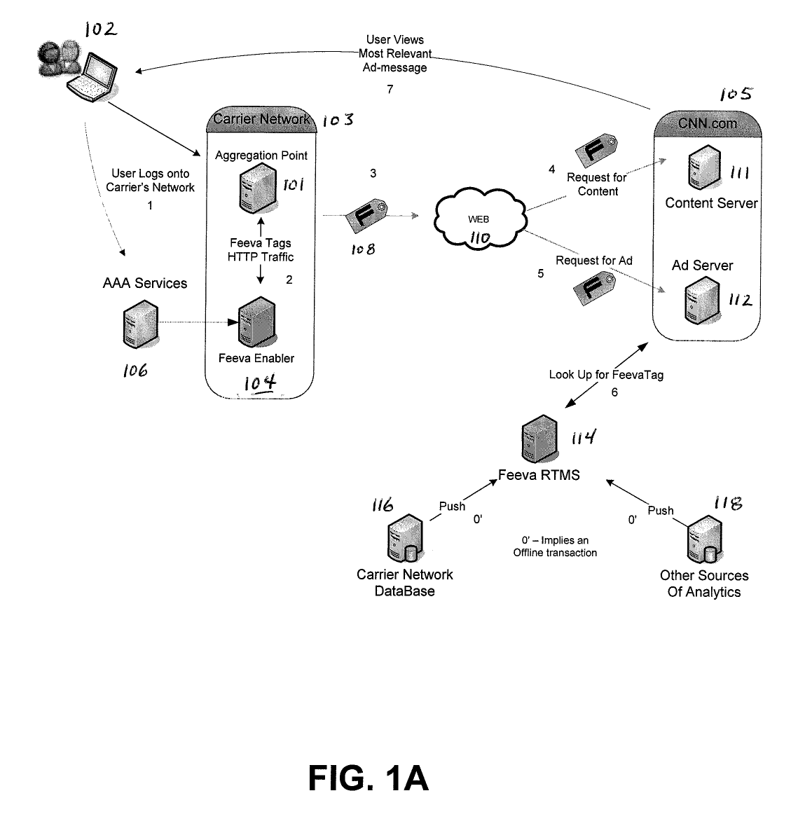

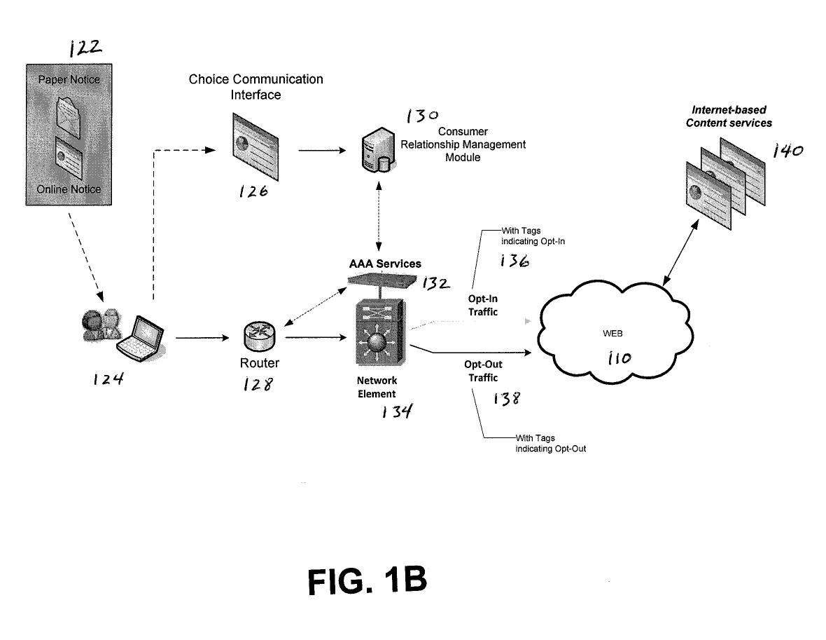

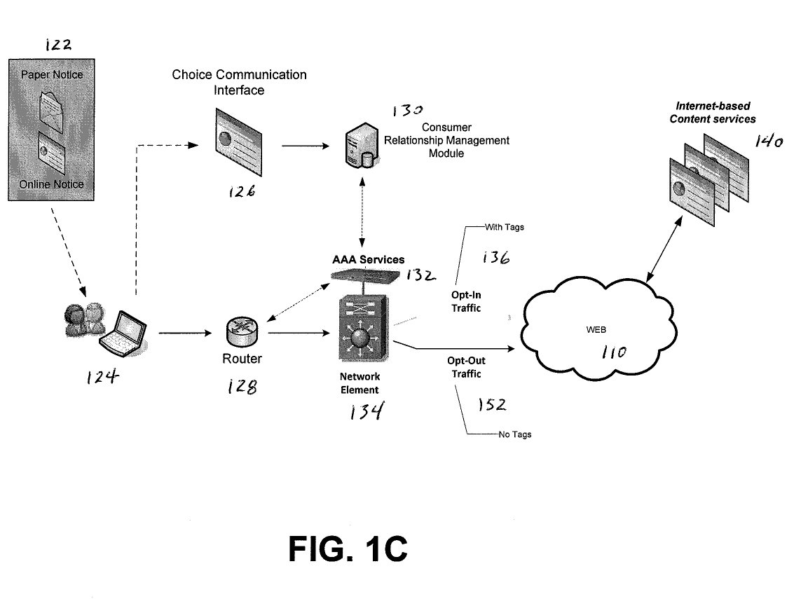

FIG. 1A illustrates a high level architectural view of a system that generates tagged Internet traffic, under an embodiment. As shown in system 100 of FIG. 1A, a user 102 logs onto a carrier network 103 (step 1). The carrier network 103 includes an aggregation point 101 and an enabler component 104. The enabler component 104 tags the HTTP traffic with an alphanumeric tag (step 2) and the tagged traffic 108 is then transmitted to the world-wide web portion of the Internet 110. In an embodiment, the user log-in request from step 1 is also transmitted to an AAA server 106 for authentication and transmission to the enabler component 104. The AAA server may implement a client-server protocol, such as the RADIUS protocol, or other similar protocols as well, that enables remote access servers to communicate with a central server to authenticate dial-in users and authorize their access to the requested system or service.

In a typical implementation, the user request will be to a content serving website, such as a commercial website 105 (e.g., CNN.com). This website comprises a content server 111 and an ad server component 112. The tagged traffic 108 is decomposed into a request for content (step 4) that is transmitted directly to the content server 111, and a request for an ad (step 5) that is transmitted to the ad server 112. The tag, which encodes certain relevant geographic/demographic information about the user 102, is passed on to an Real-Time Market Segmentation (RTMS) service 114, which decodes the tag to provide relevant information to the ad server so that the most appropriate ad can be served back to the user (step 7). The RTMS process 1114 receives information from the carrier network database 116 and other sources 118 in an offline transaction or transactions in order to provide relevant information back to the content server site 105. Similar to RTMS, other Internet-based decrypting authorities may also participate in the process of interpreting the tags, and implement application services.

The tag mechanism of FIG. 1A generally provides a sufficient balance between the need for knowledge, protection of user information, and control over tag data. A first step in this process is to inform the consumer of the existence of the tagging system within their ISP. This may be done in one of several ways, as described in greater detail below with reference to FIG. 1B. A next step is to provide the consumer with a sufficient set of tools and alternatives to create, read, update, and delete profile data associated with themselves.

A fundamental part of the system framework is grounded in the concept of meaningful consumer choice. This dictates that consumers should be able to exercise choice with respect to whether and how their personal information is used. This is true even in systems that may not use any consumer Personal Identification Information (PII). Thus, regardless of PII use, it is important that users be given a meaningful choice as to whether or not they want to participate. Failure to do so, and to do so in a meaningful manner, risks undermining the trust relationship between customers and their ISPs that is necessary for both the segmentation system administrator and the ISPs to sustain their business models.

The two primary mechanisms for exercising consumer choice in the privacy context are the opt-out method and the opt-in method. In an opt-out regime a user does not need to take any action to agree to participate. That is they accept the conditions of the information sharing unless they take the affirmative step of opting out by one of several methods (email, call center) that will be discussed in a separate section of this document. This requires minimal effort on the part of the user, but still preserves a right to be exempted from the information sharing program. When users opt-in, they are expressly agreeing to their participation in the sharing of information with their carrier or with other parties. This express agreement must take place before the information sharing can take place. In a double opt-in situation, users must also create a separate confirmation, usually by email. The advantage of this method is that there is no doubt that users have given their consent to the information usage. The downside is that most users do not respond well to opt-in systems, with an opt-in rate of 10-12% generally being considered a very good opt-in conversion rate. This is in comparison with the opt-out method, where less than 10% of users typically making that choice.

Consumers rarely opt-out of information sharing, which makes it the preferred method from a marketing perspective. However, users will opt-in where they think a sufficient return value being conferred on them, even though the actual benefits for sharing information are questionable in view of the actual return. A good example being Google's Gmail service, where users share a considerable amount of personal information in order to use the Gmail system.

There are several explanations as to why users will rarely opt-out, but very often refuse to opt-in, but the best seems to be the individuals are usually cognitive misers. Because of the number of decisions and tasks we are asked to undertake everyday individuals will tend to take decision-making short-cuts that allow them to take an action using the least amount of mental resources so that they can move on to other tasks. Very simply, it requires less cognitive effort for users to opt-out than to opt-in, and thus is more likely to occur.

With regard to the legal basis of consumer choice, opt-out is the general de facto general standard for privacy and marketing communications in the United States and the de jure standard for several important statutes relating to consumer marketing such as CAN SPAM. European Union countries more generally require an opt-in any time that PII is involved in the transaction. In the United States, opt-in is only required in fairly narrowly defined situations, such as under the CPNI (Customer Proprietary Network Information) when telecommunications carriers share PII with third parties who are not affiliates or agents. The CPNI is a good example of the fact that U.S. laws and regulations generally require opt-in only when PII or other equally sensitive data is involved. In general, a segmentation system administrator typically does not handle this type of data and does not fall under any statute or regulation that would require an opt-in mechanism. A good opt-out mechanism is one that provides clear and conspicuous notice that allows for meaningful choice by users.

There are multiple methods that can be used to provide users with a meaningful opportunity to understand the consumer choice implementation. In one embodiment, the basic methods utilize print notices, or electronic notices. While the ISPs are involved with implementing an opt-out mechanism, the system provides a stringent and durable opt-out mechanism across the spread of segmentation system networks.

Information required in the notice (regardless of what method is used) is clear and conspicuous information that describes exactly what type of information is utilized by the system administrator, how that information is obtained, what is done with it, who it is provided to, and directs the user to an obvious and easy-to-use opt-out mechanism.

Print notices are very common and very familiar to users, particularly in the financial context where the Graham-Leach-Bliley (GLB) legislation requires yearly disclosures to consumers. They have the advantage of being cheap and easily distributed, usually in billing statements or in required yearly disclosure statements. Unfortunately, a disadvantage is that the user cannot easily opt-out using a printed notice. An additional action in the form of contacting a call center, sending an email, using a web portal or even sending an old-fashioned letter may be required. There are also considerable questions as to whether or not these notices are actually effective in reaching users, with many of the consumer advocacy organizations taking the position that they are not an effective form of notice. This makes print notices a relatively poor first choice for use as an opt-out mechanism. However, print notices can make for a good secondary notice mechanism, particularly as a periodic reminder.

Electronic notices can take several forms including email, messages in the online billing interface, and the use of an interstitial web page that interrupts the user's online progress until they agree to either proceed or opt-out. Each of these methods has particular costs and benefits associated with it. Electronic mail (e-mail) notices have the advantage of being an extremely inexpensive method for sending notices. Consumers can be directed to send a reply opt-out email or directed to a portal to complete the opt-out. This is relatively easy to administer. Additionally, most users regularly use e-mail. However, e-mail notices sent to users have two principal problems. The first, and probably the most critical, is determining which e-mail address to send the notice. Customers often have multiple e-mail addresses and may not actually use the e-mail address provided by their ISP in favor of using Yahoo!, Gmail, or other popular sites. In addition, due to the volume of e-mail messages many people receive, there is the danger that the message will be ignored, deleted, or classified as spam before the user actually reads the notice.

Another electronic option is to create an interstitial page, which is a web page that is displayed before an expected content page. Interstitials have the advantage of being cheap to use (once the initial cost of constructing them is accounted for) and making sure that the user actually has the opportunity to see the notice. However, a significant problem is deciding, when, where and how often to display the interstitial page. Since many users have “always on” internet access, they may not see any type of initial log-in screen, portal or landing page. Additionally, users are noticeably hostile to “pop-up” windows and may simply delete them without looking unless there is a mechanism that prohibits closing the window without responding to the posted question. The problem with this solution is that it may also serve to irritate the user and cause them to opt-out without actually knowing the meaning of opting-out.

The increasing use of electronic billing interfaces presents an additional method of notice. Since many users are quite used to accessing their ISPs billing interface, this makes for a good location to post notice in a manner where users would first have to make a choice regarding their opt-out before proceeding with their intended tasks. The notice at this point would explain the system administrator and its practices and give them a chance to either “find out more and opt-out” or to simply agree and continue. A disadvantage of this method is that many users still handle their billing through paper statements. However, this is a case where the use of print notices bundled into billing statements would be an especially effective way of ensuring adequate notice.

In an alternative embodiment, a browser-based notice is employed that would alert browser users that tagging was being used. Through this mechanism, implemented in part by web browser companies, web users would receive a one-time notice (possibly repeated over time) that tags were being used by the user's ISP. They could then provide a mechanism for opting out.

In a further alternative embodiment, a notice is delivered to the User's mobile computing device (such as a mobile phone, netbook computer, or mobile PC) using techniques such as Short Message Services (SMS), Multimedia Message Services (MMS), and further more as advertising or content messages delivered on mobile applications (such as widgets, installed applications, etc.). The user may be directed to a portal (or other similar interface) to further communicate their choice.

There are three primary areas of impact to a system architecture in implementing the consumer choice framework. Specifically, portals are provided for the User to express choice, interfaces are provided within the service provider networks to the enabler component, and data purging mechanisms and schedules are provided to protect user data.

The portal captures a user's choice and writes it to the service provider's CRM (customer relationship management) systems. This field is further shared with the AAA/RADIUS/LDAP services typically prevalent in the network. A further integration step is required for the information within an AAA server to be transferred to the enabler component, which is performed through a Vendor Specific Attribute (VSA) on the RADIUS protocol, and can be done using other protocols as well. As stated above, RADIUS (Remote Authentication Dial-In User Service) is a client/server protocol and software that enables remote access servers to communicate with a central server to authenticate dial-in users and authorize their access to the requested system or service. RADIUS allows a company to maintain user profiles in a central database that all remote servers can share for purposes of authentication, authorization, and accounting.

A scalable architecture is implemented to ensure true opt-out. This is achieved using the RADIUS protocol, or similar protocols, to transmit the opt-out attribute to the enabler component. The transmission procedure is based on the standard process of gaining subscriber awareness at the enabler. When a subscriber authenticates with the AAA services on the network, the enabler proxies the RADIUS messages as part of the standard implementation. The opt-out field can also be populated by the service provider, and be read at the network element component using a VSA, or similar mechanism.

In the case of an opt-out selection by the user, the network element component will not insert any tags for that subscribers traffic at all times. However, this setting may be modifiable at some time post deployment as well in order to accommodate any potential changes in regulatory and user trust relationships. After an opt-out selection, digital content, advertising, and other third party partners will not tagged traffic either. In one embodiment, placeholder tags, or a similar mechanism may be inserted even for opt-out subscribers.

FIG. 1B illustrates a system architecture and process flow for implementing an opt-out scheme, under an embodiment. As shown in FIG. 1B, there is a custom opt-out interface 126 for each ISP/IAP. The user 124 is provided with a notice 122, which can be provided in paper, online, or other appropriate form. A web request for internet-based content 140 is transmitted from the user 124 through one or more routers 128. The request is also transmitted through the choice communication interface 126 of the ISP/IAP. With regard to call flows and data interchange between the customer relationship management CRM 130, the AAA server 132 and the network element 134, the user choice of opt-in or opt-out is provided as a parameter on the RADIUS protocol flows. The RADIUS protocol is commonly used for authentication, authorization, and accounting provisioning within ISP networks. A typical flow involves the customer-premise-equipment (commonly known as CPE) interacting with an AAA service to request and obtain right to service. These requests are routed through intermediate router devices 128 and relayed to the AAA servers 132. In an embodiment of the system in concern, these messages are further relayed via the network element 134 as part of regular network operations. The network element picks out attributes on the RADIUS flows to obtain necessary awareness for its application. Typical messages involved are the RADIUS ACCT-START and RADIUS ACCT-STOP messages. The RADIUS ACCT START message is originated at the AAA service, to indicate affirmation to grant service to the CPE. Similarly, the RADIUS ACCT STOP is generated by the BRAS device when the CPE is to be disconnected/deprovisioned. The network element reads the necessary attributes as parts of these messages i.e., the consumer choice is provisioned at the AAA service as a specific attribute. As shown in the embodiment of FIG. 1B, a router element 128 processes traffic based on whether the user has opted-in or opted-out. If the user opts-out, the traffic indicating this option (opt-out traffic) 138 is tagged with an appropriate tag field or code and is routed to the destination site 140 through the Internet 110. If the user opts-in, the traffic is tagged as opt-in traffic 136 and is routed in the same manner to the destination site. The opt-out and opt-in tags should be sufficiently different from one another, and may be implemented as any appropriate alphanumeric field or other coding mechanism to differentiate the tagged traffic.

FIG. 1B illustrated an embodiment in which both the opt-in traffic and opt-out traffic is tagged. Alternatively, only one type of traffic may be tagged to signify the user choice as opt-in or opt-out. FIG. 1C illustrates a system architecture and process flow for implementing an opt-out scheme, under an alternative embodiment. In this embodiment, if the user opts-out, the traffic indicating this option (opt-out traffic) 152 is not tagged at all and is routed to the destination site 140 through the Internet 110. If the user opts-in, the traffic is tagged as opt-in traffic 136 and is routed in the same manner to the destination site. This lack of a tag should be sufficient to differentiate the different types of traffic based on the user choice.

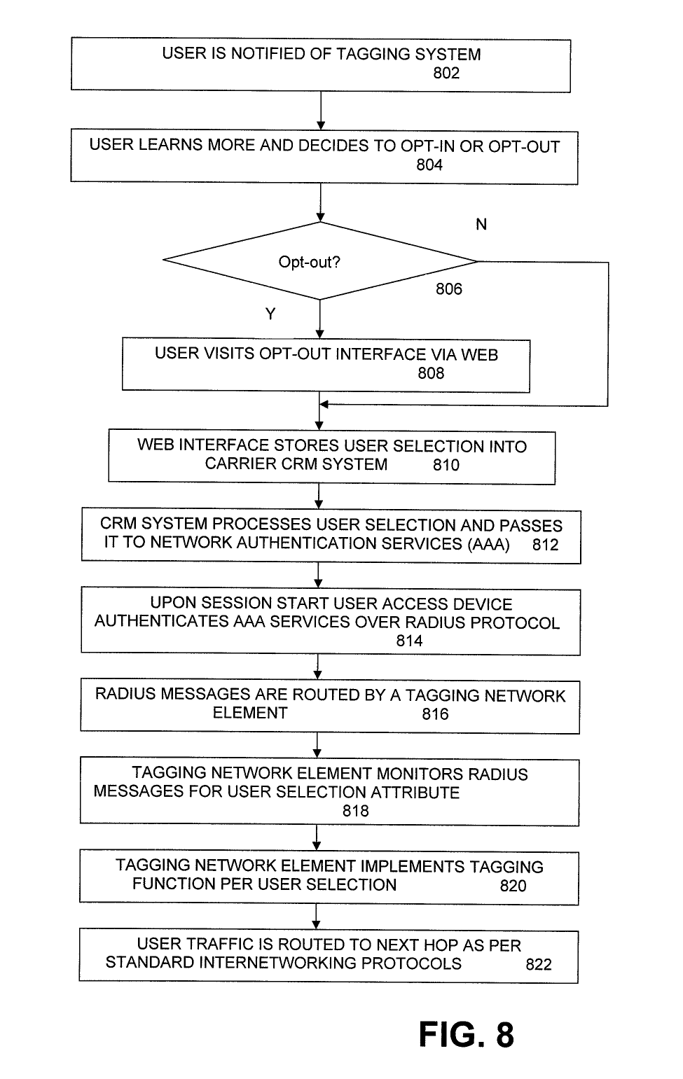

FIG. 8 is a flowchart illustrates a method of implementing a consumer choice scheme in a network environment, under an embodiment. The process of FIG. 8 starts with block 802 in which the user is notified of the presence of the tagging system. This notification can be in the form of a web page or display panel that describes the tagging system and allows the user to learn and decide about whether to opt-in or opt-out of the service, block 804. If, in block 806, the user decides to opt-out, the user is redirected or instructed to access an opt-out interface on the web, block 808. Either the opt-in or opt-out decision is stored as a user selection that is accessible by the carrier customer relations module (CRM), block 810. The CRM system processes the user selection and passes it to the network authentication services (AAA), block 812. Upon a session start, the user access device authenticates the AAA services using a RADIUS or similar protocol, block 814. The authentication messages are routed by a tagging network element, block 816. The tagging network element monitors the RADIUS messages for the user selection attribute, block 818, and implements the tagging function in accordance with the user selection, block 820. That is, if the user selected opt-in, the network traffic is tagged, otherwise it is not tagged. The user traffic is then routed to the next hop under standard Internet network protocols, block 822.

### Network Traffic Tagging System

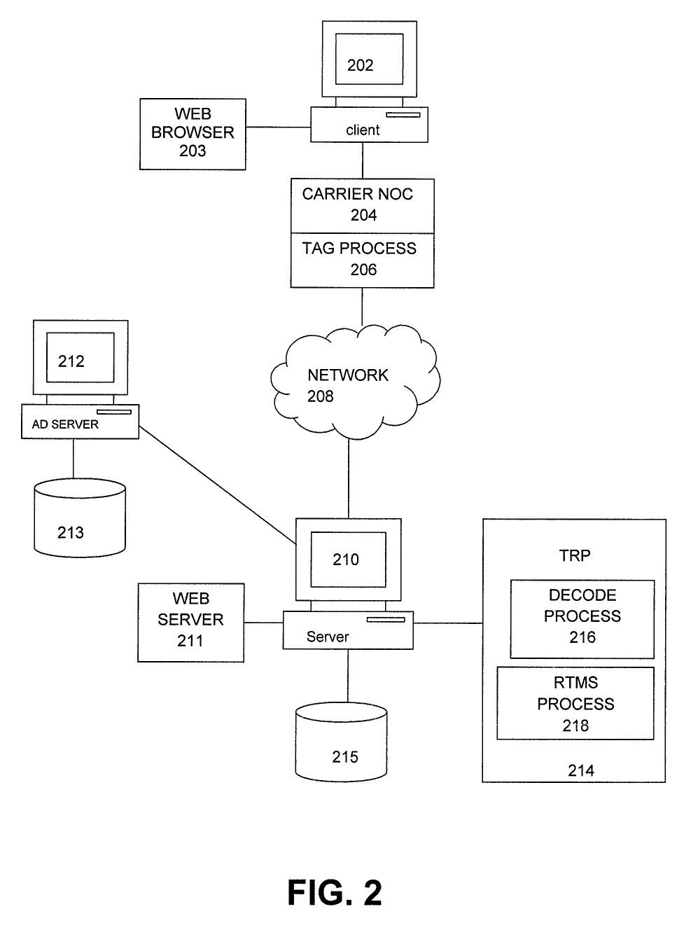

In one embodiment, a network traffic tagging component utilizes information that is collected in a telecommunications-based access network, such as WiFi, WiMAX, mobile, DSL (digital subscriber line), cable, IPTV (Internet Protocol Television), etc., to be used by destination sites, such as web server sites, publishers, content providers, peer-to-peer sites, user generated content sites, advertising networks, search engines, and so on. The network tagging component obtains relevant user and user device information, such as accurate location data and demographic information, and formats the information into a small footprint and universally accessible format. FIG. 2 illustrates a client-server network including a network tagging component, according to an embodiment. As shown in FIG. 2, a client computing device 202 accesses network 208 through a telecommunications pathway provided by carrier network operation center (NOC) 204. One or more routers may also be inserted in the transmission line between client 202 and network 208. The environment shown in FIG. 2 illustrates a standard IP-based access system in which client 202 executing a web browser process 203 accesses a web site destination served by server computer 210 executing a web server process 211. The web server 210 provides content in the form of web pages which may be sourced from a local database 215 or remotely from other servers or data stores. One or more supplemental messages, such as advertisements, may be served by an ad server 212, or similar supplemental content provider that has its own data store 213. The ad server generates ads or supplemental messages that are embedded in, or displayed in conjunction with the content served by the web server 210.

As shown in FIG. 2, a tag processor component 206 is associated with carrier NOC 204. The tag processor component 206 may be a software or hardware component that is included within the functionality provided by carrier NOC 204, or it may be a component that is tightly or loosely coupled to carrier NOC 204. The tag processor component 206 obtains certain identification information associated with the client 206 and encodes the identification information into a portion of the network traffic transmitted by client 202 to server 210. This information is then used by ad server 212 to determine which ads or messages from among a selection of ads (such as may be stored in database 213) to transmit to server 210 for incorporation into content that is served back to client 202. A separate tag related process (TRP) 214 decodes the encoded identification information and provides the corresponding geographic and location information to the server 210. The TRP 214 can also compile relevant traffic data related to the client 202, or even multiple client computers. This traffic data can then be used by ad partner 212 to dictate appropriate ad serving campaigns. For the embodiment of FIG. 2, the TRP 214 comprises a decode process 216 and an RTMS process 218 that decode tags received from the ad server 212 and provide relevant geographic/demographic data for the serving of appropriate ads to the user of client 202. Alternatively, the TRP process 214 can be used directly by the tag server process to deliver appropriate ads to the user.

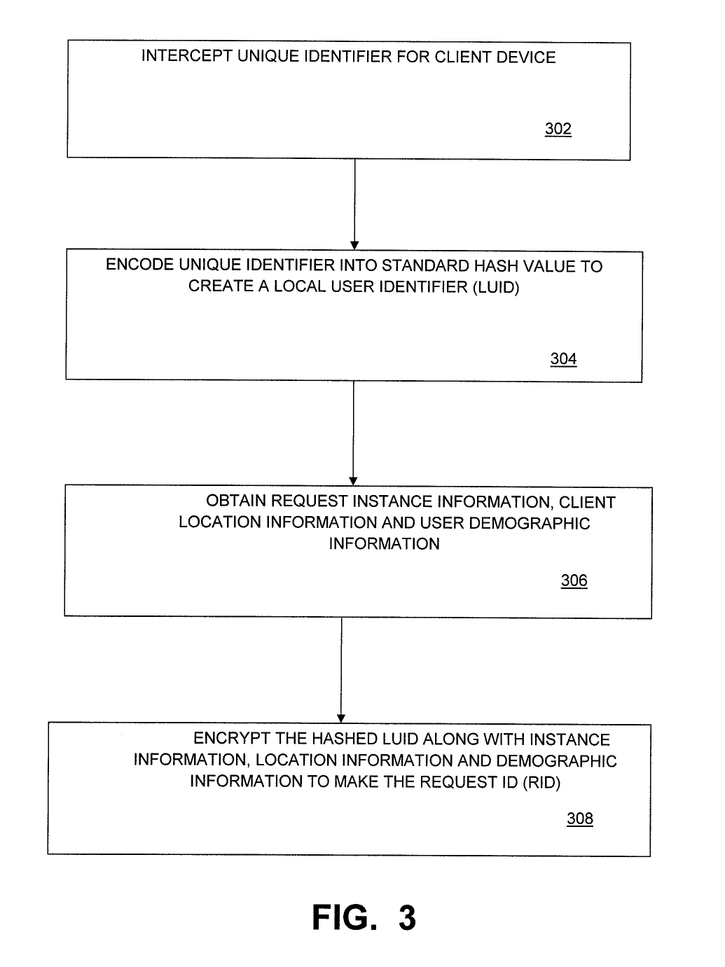

In one embodiment, the tag processor component 206 generates a unique request ID (RID) based on certain information associated with the client 202 and the user. FIG. 3 is a flowchart that illustrates a method of generating a request ID, under an embodiment. The tag processor 206 first intercepts the unique identifier (UID) for the client device, block 302. The unique identifier can be the MAC address, port identifier, or any other hardcoded unique identifier assigned to the client 202. In the case of a mobile device, such as a cellular phone, the unique identifier can be the SIM (subscriber identity module) number, or similar identifier. The UID is then encoded using a standard one-way hash algorithm to create a Local User ID (LUID), block 304. Alternatively, any equivalent coding method that ensures adequate privacy may be used to encode the UID as an LUID. In block 306, the tag processor 206 obtains instance information relating to the request, as well as location information relating to the client device and demographic information relating to the user. The instance information can comprise time of the request and can be obtained from clock or timing circuitry within the client computer, or any routing devices that transmit the request. The location information can comprise zip code, phone area code, latitude/longitude, street address, or other available location information for the client device, and may be obtained from location circuitry, such as GPS (global positioning system) circuitry within the client or any associated router or access point, or it may be provided by a database that has such location information. The demographic information can be any relevant profile information related to the user, such as gender, age, race, occupation, income level, product or service preferences, and so on, and may be provided by profile data held by the client device or third party services or related databases. The LUID is then encrypted along with the instance information, location information, and demographic information to generate a Request ID (RID), block 308.

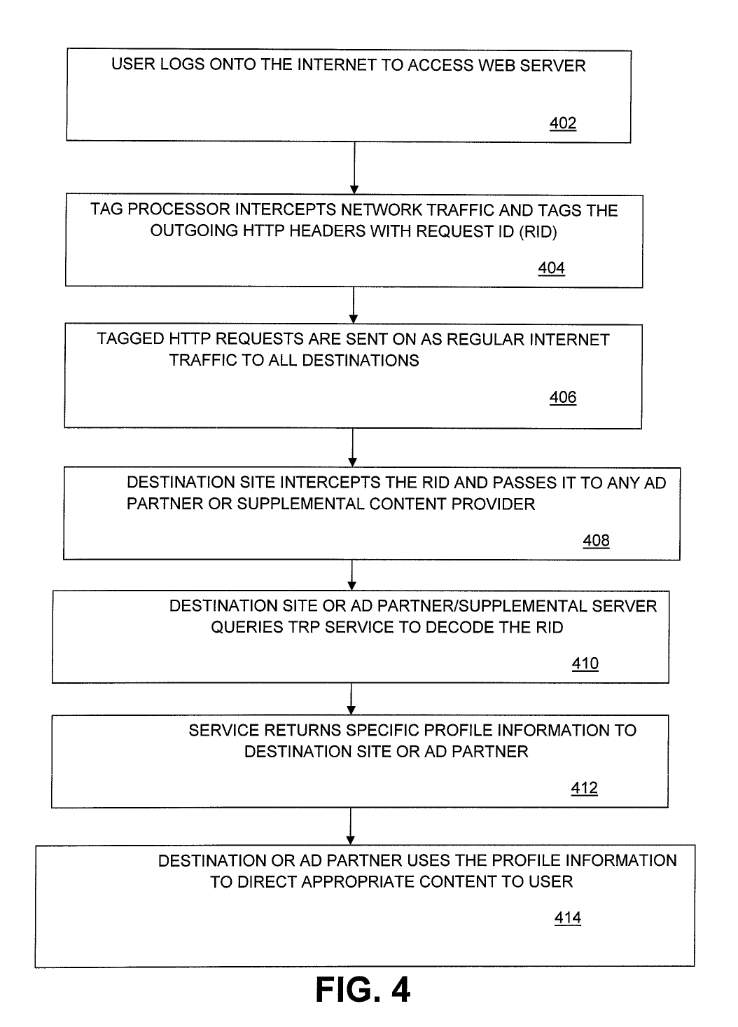

Once the RID has been generated by the tag processor, it is associated with (tagged to) the network traffic between the client and server computers. FIG. 4 is a flowchart that illustrates a method of tagging network traffic with relevant user and/or network client information, under an embodiment. In block 402, the user, through client 202, logs onto the network and attempts to connect to server 210 over the web network (Internet) 208. During this process, the HTTP requests being made will pass through the carrier NOC 204. Standard HTTP requests include various content fields, such as headers and data fields. They also accommodate incremental information from the network and adjunct databases, as these requests are distributed without filtering across the Internet. In one embodiment, the RID is encrypted in the extensible space of the HTTP header in an appropriate format. In an alternative embodiment, the TCP header can be used to encode the RID. In a further alternative embodiment, both the HTTP and TCP header can be used to encode all or respective portions of the RID.

As shown in block 404, at the carrier NOC, the tag processor processes the client network traffic comprising the HTTP requests, and tags the outgoing HTTP headers with the request ID's formed in block 308 of FIG. 3. The tagged HTTP requests are then sent on as regular Internet traffic to all destinations on the Internet, as opposed to only destinations on a single network, block 406.

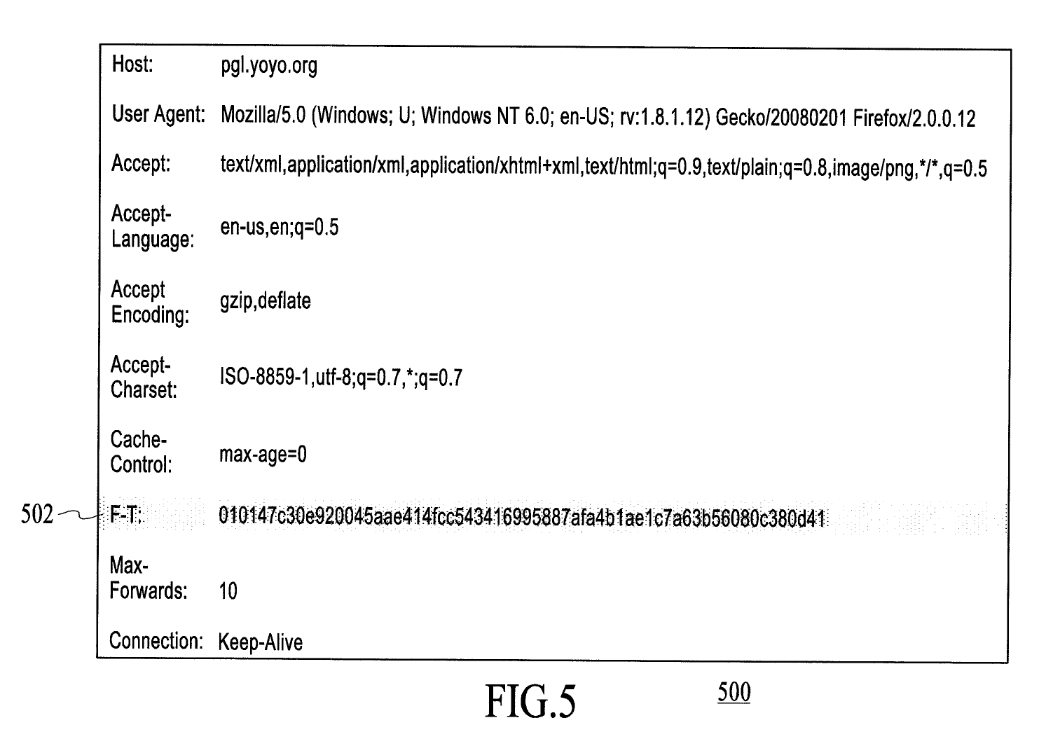

FIG. 5 illustrates an example HTTP header including a network traffic tag, according to an embodiment. The header shown in FIG. 5 has some example values entered for each of the requisite fields. A standard HTTP header includes various fields such as the Host field specifying the URL of the destination site, the User-Agent field specifying the web browser program on the client, an Accept field specifying the format accepted by the browser, an Accept Language field, an Accept Encoding field, and Accept Character Set field, a Cache Control field, a Max-Forwards field and a Connection field. The HTTP header also includes one or more extensible fields that are essentially blank, but can be used to store additional data. For the embodiment illustrated in FIG. 5, the RID is encoded in HTTP header 500 as a tag (or watermark) in a field denoted “F-T” 502. The RID tag is encoded as a hexadecimal number of a defined length. The length and position of the RID tag within the HTTP header can be modified depending upon system constraints and requirements.

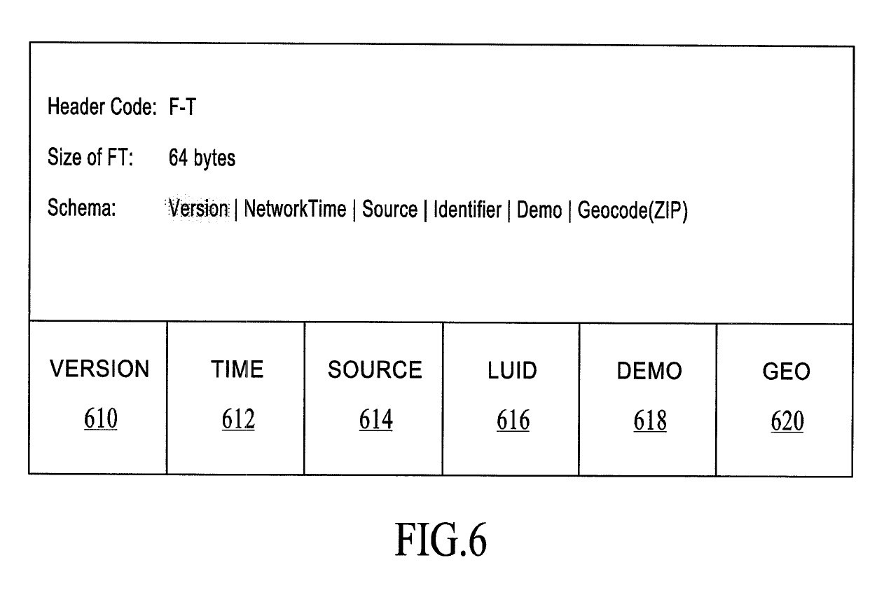

FIG. 6 illustrates the composition of the RID tag, under an embodiment. As shown in FIG. 6, the RID tag 600 is specified by a header code (e.g., F-T), and has a specified size, for example 64 bytes. The schema 602 illustrates the actual coding of the data elements within the RID. The version field 610 contains a control code that uniquely identifies the RID and is different for every HTTP request. The Time field 612 encodes the time that the request was transmitted from the client. The Source field 614 contains the unique ID associated with the client. The LUID field 616 contains the local user ID generated through the hash process executed by the tag processor component in block 304 of FIG. 3. The Demographic field 618 encodes the demographic data for the user. The Geographic field 620 encodes the location data of the client device. As shown in field 502 of FIG. 5, an example RID tag in the F-T field comprises the values for each of these fields into a single hexadecimal number of length 64-bytes. Each individual field can be encoded according to a specific scheme. For example, the geographic data could comprise zip or zip+4 data, latitude/longitude, or street address data that is encoded into a corresponding hexadecimal number. Likewise, the demographic data comprises a hexadecimal number that corresponds to the profile information relating to various characteristics (e.g., gender, race, age, etc.) of the user. Actual coding schemes can be defined by the user. Similarly, each of the other fields encodes their respective data into hexadecimal values. Alternatively, any other appropriate numerical base, other than hexadecimal, could be used to encode the RID tag. In one embodiment, the tag structure of FIG. 6 may be modified or extended to include an opt-in/opt-out flag or field that indicates whether the user has elected to opt-in or opt-out of the tagging system. Alternatively, a separate tag indicating just an opt-in selection, just an opt-out selection, or either an opt-in or opt-out selection can be appended to or associated with the tag of FIG. 6.

With reference to FIG. 4, in block 408, the destination site intercepts the RID from the HTTP header and passes it on to any associated ad partner or supplemental content provider. Many popular web destinations use advertising partners to provide and place ads. They may also have content partners or search engines or other media/content services. These supplemental servers are normally used to send a request for particular information related both to the destination website as the request from the user. The RID is used to enhance the relevance of the ads or supplemental messages provided by these supplemental servers. It can be used to select appropriate ads from a set of ads, or tailor ads for specific users by insertion of customized information. In the case of a TCP option request, sockets are used to extract the RID information and require either a software stack or network appliance.

In general, the destination site (server computer 210 or ad partner 212) receive and collect the tagged RIDs as they are extracted from the HTTP requests sent by the client computer. In one embodiment, they may be provided with decoding capability so that they can extract the corresponding location and demographic information directly themselves. In a preferred embodiment, however, this decoding process is provided by a separate process provided by TRP 214. Thus, for the embodiment shown in FIG. 4, in block 410, the destination site, or the ad server/supplemental server queries TRP 214 to decipher the true value embedded in the request ID. This is typically accomplished by decoding the RID value encoded in the HTTP (or TCP) header. The TRP then returns specific profile information to the destination site or ad partner. This information comprises the geographic (location) demographic, technographic, psychographic, or other values pertaining to the RID. The destination or ad partner then uses the profile information to direct appropriate content to the user, block 414. This appropriate content is referred to as “directed media” and can comprise a media tag identifying a media or type of media, and can consist of or reference advertisement messages, coupons, video content, audio content, or any other media which is tailored to the user identity, location, and/or preferences.

In one embodiment, the user information (e.g., geographic, demographic, psychographic information) for the tag is obtained at run-time. In the context of an ad-serving application or any other third party content or supplemental message serving system, run-time refers to the moment when the ad or supplemental message is served to the user and displayed on the user device. For this embodiment, the tag is decrypted by the content provider in real-time coincident with the web-based request by the user. This allows the content provider to serve the appropriate message or ad based on the generic anonymous data of the user, thus enabling the delivery of targeted content to specific users or classes of users. The combination of real-time serving and decryption of tag information relating to the user efficiently enables the creation of dynamic ad campaigns and effective targeted ad serving to large populations of users. According to embodiments described herein, network statistics regarding a plurality of users can be obtained at runtime by the content provider and used for the aggregation of metrics regarding the users. This facilitates the creation of comprehensive ad campaigns and targeted content serving based user preferences, geographic data, and other related data that are tied to and obtained from persistent profiles associated with each individual user.

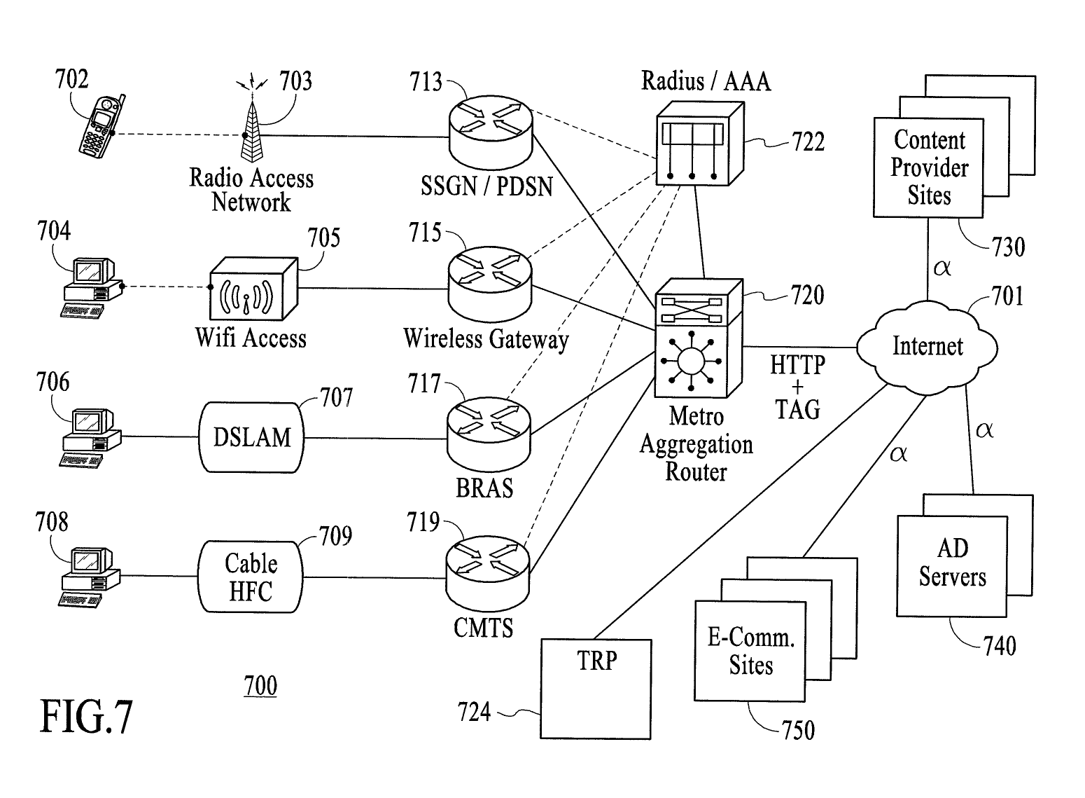

As shown in FIG. 2, a network system connecting a client computer to a destination site maintained by a server computer can include several different types of client computers, as well as several different supplemental content providers. FIG. 7 illustrates a network system including a tag processor component within a router for multiple different client devices, under an embodiment. As shown in FIG. 7, a number of different client computers are coupled to a single router 720 through various access points and gateway/router devices. For example, a mobile phone 702 access router 720 through a radio access network 703 and an SSGN/PDSN (Serving GPRS Support Node/Packet Data Serving Node) router 713. Wireless client 704 goes through a wireless access point 705 and wireless gateway 715 to access router 720. Home client computer 706 accesses router 720 through a Digital Subscriber Line Access Multiplexer (DSLAM) 706 and a broadband remote access server (BRAS) 717. Client computer 708 utilizes a cable HFC (hybrid fiber coax) modem or router 709 and accesses router 720 through cable modem termination system (CMTS) 719. Each client computer has a unique ID, such as a MAC address, SIM address, or the like. An authentication server 722, such as provided by Radius/AAA authenticates the client ID associated with each gateway that is connected to router 720. In one embodiment, router 720 includes or is tightly coupled to a tag process component. This component generates an RID from an LUID and certain geographic/demographic information, as shown in FIG. 3 and FIG. 4. It also encodes the RID information as a tag in the HTTP header of the network traffic from the respective client computer. The HTTP header and tag (or watermark) is then transmitted over Internet 701 to the destination site. The existence of the RID tag UID's during different stages of network processing is depicted in FIG. 7 by the “a” symbol. The destination site could be an e-commerce site 750 that is associated with one or more of an ad server 740 and/or a supplemental content provider site 730. The TRP 724 decodes the RID information for use by the destination site and any associated ad or supplemental server site.

Embodiments of a method for implementing consumer choice in a content delivery system are disclosed. Embodiments are generally directed to implementing a centralized consumer choice process covering multiple Internet-based content services, comprising: transmitting a consumer choice notification message to a user, receiving an indication of consumer choice with regard to gathering, storing or sharing of consumer information and activity during user Internet activity, wherein the consumer choice may comprise one of an opt-out or opt-in selection, storing the indicated consumer choice in a customer relationship management module, and setting a protocol in a network routing device to tag network traffic bound for a remote Internet-based content service indicating the user's choice.

What is disclosed are methods and systems for implementing a centralized consumer choice process covering multiple Internet-based content services, comprising: transmitting a consumer choice notification message to a user; receiving an indication of consumer choice with regard to gathering, storing or sharing of consumer information and activity during user Internet activity, wherein the consumer choice may comprise one of an opt-out or opt-in selection, and is received through a user interface executed on a client computer operated by the user; storing the indicated consumer choice in a customer relationship management module; setting a first protocol selection in a network routing device to tag network traffic bound for the remote Internet-based content services in cases where the consumer choice selection is to opt-in to a tagging process; and setting a second protocol selection in the network routing device whereby network traffic bound for the remote Internet-based content services is not tagged in cases where the consumer choice selection is to opt-out of the tagging process. In this method, there may be a plurality of methods for the transmission of the choice notification to the user. These can include: transmission to the user through an electronic mail notice sent directly to a user electronic mail account, display to the user through an interstitial web page displayed during a web browsing session of the user, transmission to the user through an electronic billing interface, transmission to the user through an SMS message, provision to the user through labeling associated with ads or content shown to the user, and provision through a user interface as part of an application executed on the client computer. The method can further comprise transmitting the choice notification to the user through a paper notice transmitted to the user by one of mail or fax.

In an embodiment, the choice notification by the user impacts a plurality of methods of gathering, storing, or sharing of consumer information transmitted by an Internet Service Provider (ISP), and data for the plurality of methods is selected from the group consisting of: explicitly conveyance by the user to the ISP, derivation by the ISP through inference tools; derivation by the ISP through monitoring of user activity, and derivation by the ISP through contracting third parties for such information.

In an alternative embodiment, the choice notification by the user impacts a plurality of methods of gathering, storing, or sharing of consumer information transmitted by one or more Internet-based content services, and the data for the plurality of methods is selected from the group consisting of: explicitly conveyance by the user to the Internet-based content service, derivation by the Internet-based content service through inference tools; derivation by the Internet-based content service through monitoring of user activity, and derivation by the Internet-based content service through contracting third parties for such information.

A customer relationship management module may be used for storing the consumer choice selection, and it may be maintained by one of: an Internet Service Provider (ISP), an Internet-based content service, and a third-party.

Aspects of the network traffic tagging and consumer choice implementation system described herein may be implemented as functionality programmed into any of a variety of circuitry, including programmable logic devices (“PLDs”), such as field programmable gate arrays (“FPGAs”), programmable array logic (“PAL”) devices, electrically programmable logic and memory devices and standard cell-based devices, as well as application specific integrated circuits. Some other possibilities for implementing aspects of the method include: microcontrollers with memory (such as EEPROM), embedded microprocessors, firmware, software, etc. Furthermore, aspects of the described method may be embodied in microprocessors having software-based circuit emulation, discrete logic (sequential and combinatorial), custom devices, fuzzy (neural) logic, quantum devices, and hybrids of any of the above device types.

It should also be noted that the various functions disclosed herein may be described using any number of combinations of hardware, firmware, and/or as data and/or instructions embodied in various machine-readable or computer-readable media, in terms of their behavioral, register transfer, logic component, and/or other characteristics. Computer-readable media in which such formatted data and/or instructions may be embodied include, but are not limited to, non-volatile storage media in various forms (e.g., optical, magnetic or semiconductor storage media) and carrier waves that may be used to transfer such formatted data and/or instructions through wireless, optical, or wired signaling media or any combination thereof. Examples of transfers of such formatted data and/or instructions by carrier waves include, but are not limited to, transfers (uploads, downloads, e-mail, etc.) over the Internet and/or other computer networks via one or more data transfer protocols (e.g., HTTP, FTP, SMTP, and so on).

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

The above description of illustrated embodiments of the network traffic tagging system is not intended to be exhaustive or to limit the embodiments to the precise form or instructions disclosed. While specific embodiments of, and examples for the system are described herein for illustrative purposes, various equivalent modifications are possible within the scope of the described embodiments, as those skilled in the relevant art will recognize.

The elements and acts of the various embodiments described above can be combined to provide further embodiments. These and other changes can be made to the network traffic tagging system in light of the above detailed description.

In general, in any following claims, the terms used should not be construed to limit the described system to the specific embodiments disclosed in the specification and the claims, but should be construed to include all operations or processes that operate under the claims. Accordingly, the described system is not limited by the disclosure, but instead the scope of the recited method is to be determined entirely by the claims.

While certain aspects of the online loan application system may be presented in certain forms, the inventors contemplate the various aspects of the methodology in any number of forms. For example, while only one aspect of the system is recited as embodied in machine-readable medium, other aspects may likewise be embodied in machine-readable medium.

What is claimed is:

1. A method of implementing a centralized consumer choice process covering multiple Internet-based content services, comprising:
transmitting a consumer choice notification message to a user;
receiving an indication of consumer choice with regard to gathering, storing or sharing of consumer information and activity during user Internet activity, wherein the consumer choice may comprise one of an opt-out or opt-in selection;
storing the indicated consumer choice in a customer relationship management module; and
setting a protocol in a network routing device to tag network traffic bound for a remote Internet-based content service indicating the user's choice.

2. The method of claim 1 wherein reception of the tag indicates to the Internet-based content services that the user has agreed to participate in the gathering, storing, or sharing of defined user information.

3. The method of claim 1 wherein the absence of a tag indicates to Internet-based content services, that the user has declined to participate in the gathering, storing, or sharing of defined user information.

4. The method of claim 1 wherein reception of a first type of tag indicates to the Internet-based content services that the user has agreed to participate in the gathering, storing, or sharing of defined user information.

5. The method of claim 1 wherein reception of a second type of tag indicates to Internet-based content services, that the user has declined to participate in the gathering, storing, or sharing of defined user information.

6. The method of claim 1 wherein the system offers a plurality of methods for the transmission of the choice notification to the user.

7. The method of claim 6 wherein the choice notification transmission method is selected from the group consisting of: transmission to the user through an electronic mail notice sent directly to a user electronic mail account, display to the user through an interstitial web page displayed during a web browsing session of the user, transmission to the user through an electronic billing interface, transmission to the user through an SMS message, provision to the user through labeling associated with ads or content shown to the user, and provision through a user interface as part of an application executed on the client computer.

8. The method of claim 6 further comprising transmitting the choice notification to the user through a paper notice transmitted to the user by one of mail or fax.

9. The method of claim 1 wherein the choice notification by the user impacts a plurality of methods of gathering, storing, or sharing of consumer information transmitted by an Internet Service Provider (ISP).

10. The method of claim 9 wherein data for the plurality of methods is selected from the group consisting of: explicitly conveyance by the user to the ISP, derivation by the ISP through inference tools; derivation by the ISP through monitoring of user activity, and derivation by the ISP through contracting third parties for such information.

11. The method of claim 1 wherein the choice notification by the user impacts a plurality of methods of gathering, storing, or sharing of consumer information transmitted by one or more Internet-based content services.

12. The method of claim 11 wherein data for the plurality of methods is selected from the group consisting of: explicitly conveyance by the user to the Internet-based content service, derivation by the Internet-based content service through inference tools; derivation by the Internet-based content service through monitoring of user activity, and derivation by the Internet-based content service through contracting third parties for such information.

13. The method of claim 1 wherein the customer relationship management module used for storing the consumer choice selection is maintained by one of: an Internet Service Provider (ISP), an Internet-based content service, and a third-party.

14. A method of implementing a centralized consumer choice process covering multiple Internet-based content services, comprising:
transmitting a consumer choice notification message to a user;
receiving an indication of consumer choice with regard to gathering, storing or sharing of consumer information and activity during user Internet activity, wherein the consumer choice may comprise one of an opt-out or opt-in selection, and is received through a user interface;
storing the indicated consumer choice in a customer relationship management module;
setting a first protocol selection in a network routing device to tag network traffic bound for the remote Internet-based content services in cases where the consumer choice selection is to opt-in to a tagging process; and
setting a second protocol selection in a network routing device where by network traffic bound for the remote Internet-based content services is not tagged in cases where the consumer choice selection is to opt-out of the tagging process.

15. The method of claim 14 wherein the system offers a plurality of methods for the transmission of the choice notification to the user.

16. The method of claim 15 wherein the choice notification transmission method is selected from the group consisting of: transmission to the user through an electronic mail notice sent directly to a user electronic mail account, display to the user through an interstitial web page displayed during a web browsing session of the user, transmission to the user through an electronic billing interface, transmission to the user through an SMS message, provision to the user through labeling associated with ads or content shown to the user, and provision through a user interface as part of an application executed on the client computer.

17. The method of claim 16 further comprising transmitting the choice notification to the user through a paper notice transmitted to the user by one of mail or fax.

18. The method of claim 14 wherein the choice notification by the user impacts a plurality of methods of gathering, storing, or sharing of consumer information transmitted by an Internet Service Provider (ISP).

19. The method of claim 18 wherein data for the plurality of methods is selected from the group consisting of: explicitly conveyance by the user to the ISP, derivation by the ISP through inference tools; derivation by the ISP through monitoring of user activity, and derivation by the ISP through contracting third parties for such information.

20. The method of claim 14 wherein the choice notification by the user impacts a plurality of methods of gathering, storing, or sharing of consumer information transmitted by one or more Internet-based content services.

21. The method of claim 20 wherein data for the plurality of methods is selected from the group consisting of: explicitly conveyance by the user to the Internet-based content service, derivation by the Internet-based content service through inference tools; derivation by the Internet-based content service through monitoring of user activity, and derivation by the Internet-based content service through contracting third parties for such information.

22. The method of claim 14 wherein the customer relationship management module used for storing the consumer choice selection is maintained by one of: an Internet Service Provider (ISP), an Internet-based content service, and a third-party.
